(19) United States
(12) Patent Application Publication
(10) Pub. No.: US 2008/0014911 A1
(43) Pub. Date: Jan. 17, 2008

(54) GROUP SHARING OF MEDIA CONTENT

(76) Inventors: Jonathan William MEDVED, Jerusalem (IL); David Elliot Goldfarb, Beit Shemesh (IL)

Correspondence Address: DANIEL J SWIRSKY, 55 REUVEN ST., BEIT SHEMESH, 99544, omitted

(21) Appl. No.: 11/776,689

(22) Filed: Jul. 12, 2007

Related U.S. Application Data
(60) Provisional application No. 60/830,355, filed on Jul. 13, 2006.

(51) Int. Cl. H04M 3/493; G06F 17/30

(52) U.S. Cl. 455/414.2; 707/104.1; 707/E17.032

(57) ABSTRACT

A communications device includes a personalization content manager and a media player. The manager receives group media clips of a group that shares common media content. The media player plays at least one of the group media clips on the occasion of call-related activity with another of the members. A method includes enabling members of a group to define a media clip for use as a common call-related media tone for the members.

### CROSS-REFERENCE TO RELATED APPLICATIONS

This application claims benefit from U.S. Provisional Patent Application 60/830,355, filed Jul. 13, 2006, which is hereby incorporated in its entirety by reference.

### FIELD OF THE INVENTION

The present invention relates to shared personalization content generally.

### BACKGROUND OF THE INVENTION

FIG. 1, to which reference is now made, illustrates a media content sharing system 100 described in prior patent applications U.S. 60/771,883 and 60/772,564, now incorporated into U.S. patent application Ser. No. 11/544,938, assigned to the common assignee of the present application and incorporated herein by reference. When the content is video ringtones, the video ringtone chosen by the calling party is displayed on the called handset.

FIG. 1 shows a communication device 110, owned by, for example, Jack, and a telephone 120, owned by, for example, Jill, who are simultaneously setting up or using a voice connection 140 for a telephone conversation. Jack and Jill are members of a content sharing community 150 and use a community server 130 for the selection and download of content, such as media clips (which may include video clips, audio clips, etc.), to be played on communication device 110. In the example, Jack and Jill are also “buddies”, members of community 150 who elect to share content with each other.

Community server 130 comprises a media clip selection database 132 which stores a collection of media clips 134 for selection by members of community 150. Jill accesses community server 130 via an Internet connection (arrow 131) and then selects a media clip 134 for her video ringtone.

A software client (not shown) on Jack's communication device 110 then downloads (arrow 133) Jill's media clip 134 to device 110. Communication device 110 comprises a media player 112, a personalization content manager 137, and buddy media clip database 138. Buddy media clip database 138 stores media clips 136 which are copied versions of media clips 134 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 136 originally selected by Jill and plays it as a video ringtone on media player 112, thus playing Jill's selected clip on Jack's phone when Jill calls.

Community 150 is also used in a similar manner to download other variations of video ringtones. For example, Jill can select a media clip 134 for a video ringback tone as well. After the selected media clip 134 is downloaded to Jack's device 110, it can be played as a video ringback tone when he calls Jill. U.S. Patent application 60/771,883 and 60/772,564 also describe how community 150 can be used in a similar manner to select and distribute “ringbye tones” which are played at the end of a phone conversation and other tones.

U.S. patent application 60/816,888 and 60/829,896, now incorporated into U.S. patent application Ser. No. 11/768,989, assigned to the common assignees of the present application and incorporated herein by reference, describe a method for a user to post user provided media clips to community server 130. Such user provided media clips are then downloaded instead of media clips 134 to communications devices 110 belonging to the posting user's buddies.

### SUMMARY OF THE PRESENT INVENTION

There is provided, in accordance with a preferred embodiment of the present invention, a method including enabling members of a group to define a media clip for use as a common call-related media tone for the members.

Moreover, in accordance with a preferred embodiment of the present invention, the enabling includes downloading the latest media clip to communications devices of the members after receipt of a latest media clip from one member of the group after its receipt from one member of the group.

Additionally, in accordance with a preferred embodiment of the present invention, the method also includes providing a listing with details regarding the media clips to the communications devices. The details might include at least one of the following: a name for the member that posted the media clip, a posting time stamp, an identifier for the media clip, an associated media clip, a link to an associated media clip, and a text message.

Moreover, in accordance with a preferred embodiment of the present invention, the details are sorted according to the posted time stamps.

Further, in accordance with a preferred embodiment of the present invention, the method also includes enabling the members to select and play the media clip from the listing.

There is also provided, in accordance with a preferred embodiment of the present invention, a method including receiving group media clips on a communications device of a user belonging to a group that shares common media content and playing at least one of the group media clips on the occasion of call-related activity between the user and another of the members.

Further, in accordance with a preferred embodiment of the present invention, the played media clip is the most recently defined common media content available.

Additionally, in accordance with a preferred embodiment of the present invention, the method also includes associating the received group media clip with each member of the group. It may also include, in accordance with a preferred embodiment of the present invention, receiving details, as described hereinabove, regarding the media clips.

Moreover, in accordance with a preferred embodiment of the present invention, the method also includes enabling the user to select and play the media clip from the listing.

There is also provided, in accordance with a preferred embodiment of the present invention, an apparatus including a database to store media clips and a group manager to enable members of a group to define a media clip from the database for use as a common call-related media tone for the members.

Additionally, in accordance with a preferred embodiment of the present invention, the apparatus also includes a downloader to download a latest media clip defined by one member of the group to communications devices of the members.

Moreover, in accordance with a preferred embodiment of the present invention, the group manager includes a group table with details, as described hereinabove, regarding the media clips.

Further, in accordance with a preferred embodiment of the present invention, the apparatus includes a downloader to download the table to the communications devices.

There is also provided, in accordance with a preferred embodiment of the present invention, a communications device including a personalization content manager and a media player. The personalization content manager receives group media clips of a group that shares common media content. The media player plays at least one of the group media clips on the occasion of call-related activity with another of the members.

Further, in accordance with a preferred embodiment of the present invention, the played media clip is the most recently defined the common media content available.

Still further, in accordance with a preferred embodiment of the present invention, the personalization content manager includes an associator to associate the received group media clip with each member of the group.

Moreover, in accordance with a preferred embodiment of the present invention, the personalization content manager includes a listing of details, as described hereinabove, regarding the media clips.

Finally, in accordance with a preferred embodiment of the present invention, the personalization content manager includes a unit to enable the user to select and play the media clip from the listing.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a media content sharing system for the selection and distribution of media content, such as video ringtones;

FIG. 2 is a schematic illustration of a group sharing system for media content, constructed and operative in accordance with a preferred embodiment of the present invention;

FIG. 3 is a schematic illustration of a group media clip table, useful in the system of FIG. 2;

FIG. 4A is a flow chart illustration of a method by which a communications device may process an incoming media clip, useful in the system of FIG. 2;

FIG. 4B is a flow chart illustration of a process for displaying a media clip, useful in the system of FIG. 2;

FIG. 5 is a schematic illustration of an exemplary listing of media clips, useful in the system of FIG. 2; and

FIG. 6 is a flow chart illustration of an alternative embodiment of the process of FIG. 4A.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

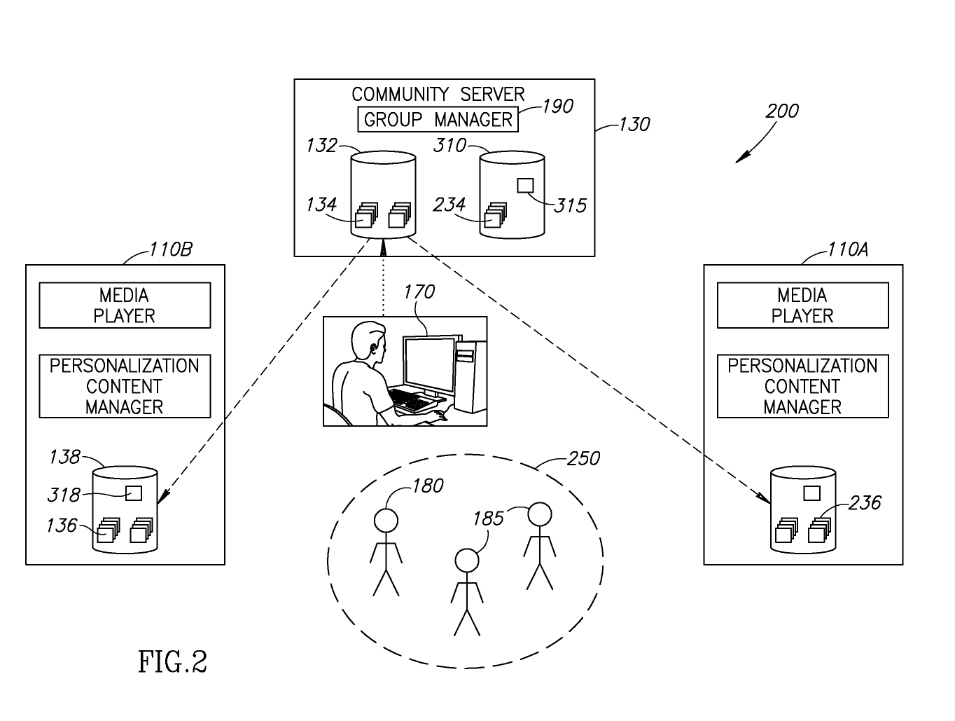

The present invention may be a novel method enabling users to share media clips with a multiplicity of other users belonging to the same group. Reference is now made to FIG. 2, which illustrates a novel system 200 for such sharing, constructed and operative in accordance with the present invention.

System 200 may comprise a community server 130 and communications devices 110. Community server 130 may comprise a media clip database 132 which may store media clips 134. Community server 130 may also comprise a group manager 190 and a group media clip database 310. Group media clip database 310 may store posted media clips 234 and group media clip table 315. It will be appreciated that media clip database 132 and group media clip database 310 may be two logical entities implemented in a single physical database.

Communications devices 110 may be used by a group 250 of users to communicate with each other and with community server 130. Each member of group 250 may also use his/her personal computer 170 to communicate with community server 130.

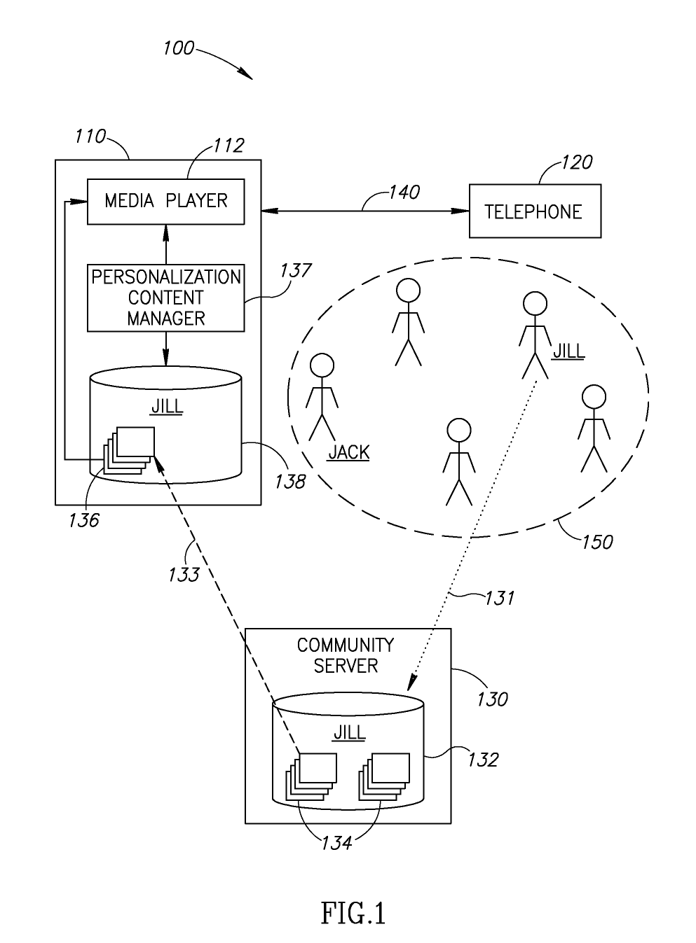

Group 250 may typically comprise an individual user 180 and his or her buddies 185 from among community 150 (FIG. 1). The members of group 250 may all agree that their call related media tones may be determined collectively by the members of group 250. It will be appreciated that user 180 may have other buddies (not shown) that have not joined group 250. Individually selected call-related media tones may continue to be used when user 180 converses with these buddies, as in the prior art.

Group manager 190 may comprise an opt-in function (not shown) to enable members of group 250 to indicate such agreement. Members of group 250 may use their personal computer 170, their communications device 110, or any other suitable devices to access group manager 190 via a wide area communications network such as the Internet.

From time to time, individual members of group 250 may “post” media clips 234 to group media clip database 310 for use as a common call-related media tone for all of the members of group 250. Media clips 234 may be posted by selecting from among system provided media clips 134. In accordance with an alternative preferred embodiment of the present invention, media clips 234 may also be posted from external sources as described in U.S. patent application Ser. No. 11/768,989. Each member of group 250 may access group media database 310 may be accessed from his/her personal computer 170, communications device 110, or any other device that may be suitable to access community server 130 via a wide area network such as the Internet.

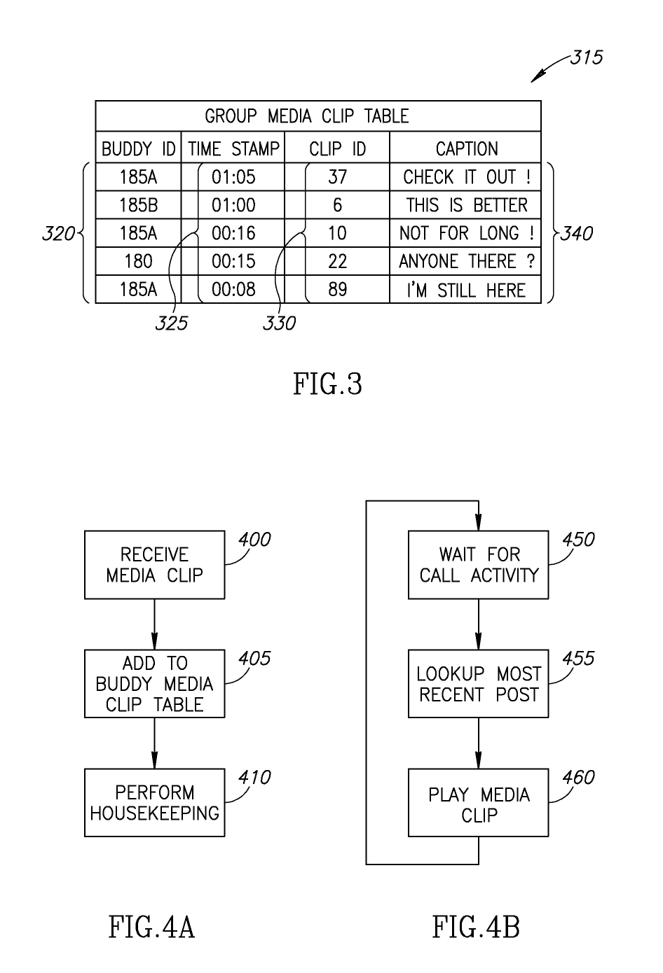

Group manager 190 may add a record to group media clip table 315 for each media clip 234 posted. FIG. 3, to which reference is now made, illustrates an exemplary group media clip table 315. Table 315 may comprise a buddy ID 320, a time stamp 325, a clip ID 330 and a caption 340 for each media clip 234 posted. It will be appreciated that clip ID 330 may be any kind of identifier, such as a number or a URL. Table 315 may also list an associated media clip and a link to the associated media clip.

After a media clip 234 is posted on community server 130, a copy of it may then be downloaded to communications devices 110 associated with members of group 250. A copy of its associated record from group media clip table 315 may also be downloaded at the same time.

Returning to FIG. 2, as in the prior art, communications devices 110 may comprise a media player 112, a personalization content manager 137 and a buddy media clip database 138 storing media clips 136. However, in accordance with a preferred embodiment of the present invention, buddy media clip database 138 may also comprise a local version of group media clip table 315, herein labeled buddy media clip table 318.

Media clip 234 may be stored as media clip 136 in buddy media clip database 138. Similarly, the associated record from group media clip table 315 may be copied into buddy media clip table 318.

Personalization content manager 137 may use time stamps 325 from buddy media clip table 315 to determine a most recently posted media clip 136. It may then designate the most recently received media clip 136 as the current media clip to forward to media player 112 to play on the occasion of any relevant call-related activity. It will be appreciated that such designation may generally occur in parallel on each of the communications devices 110 in use by members of group 250. Accordingly, each member of group 250 may have the same media clip 136 designated to be played the next time their associated communication device 110 is engaged in call-related activity with another member of group 250.

Reference is now made to FIGS. 4A and 4B which illustrate two processes that may be performed in parallel on communications devices 110. FIG. 4A shows a process by which communications device 110 may process an incoming media clip 136 as it may be downloaded from community server 130 and FIG. 4B shows a process of displaying media clip 136.

In FIG. 4A, communications device 110 may receive (step 400) an incoming media clip and store it in buddy media clip database 138. The download may be effected via a TCP data channel initiated by communications device 110. Communications device 110 may keep the TCP data channel open by periodic transmissions to community server 130. Communications device 110 may also re-open the channel whenever it “times out” and closes. In accordance with an alternative embodiment of the present invention, communications devices 110 may also use an HTTP connection to periodically poll community server 130 for available downloads. It will be appreciated that any other well-known available channel may be used for such transmission.

Personalization content manager 137 may add (step 405) an associated record to buddy media clip table 318. It will be appreciated that due to timing issues and/or interference on the network, incoming media clips 136 may not always arrive in the order in which they were originally posted on community server 130. However, manager 137 may use time stamps 325 to establish sequential order.

The number of entries in buddy media clip table 318 may be limited. Similarly the amount of disk space to be used by media clips 136 may also be limited. Accordingly, personalization content manager 137 may perform (step 410) housekeeping procedures such as “pruning” entries from table 318 and/or deleting older media clips 136 from database 132. It will be appreciated that step 410 may be performed at other times as well.

The process illustrated in FIG. 4A may be initiated whenever a new media clip 136 may be received. The process illustrated in FIG. 4B may run continually whenever communications device 110 is in use. Personalization content manager 137 may wait (step 450) for call activity. As discussed in U.S. patent application Ser. No. 11/544,938 such activity may consist of, for example, an outgoing call, an incoming call, or the end of a call. When such activity is detected, personalization content manager 137 may lookup (step 455) the most recent entry in buddy media clip table 318 (according to time stamps 325) and may play (step 460) associated media clip 136 by launching media player 112.

It will be appreciated that the processes of FIGS. 4A and 4B may not have a synchronous relationship. The frequency of the execution of the process of FIG. 4A may be generally determined by the frequency of posts by the members of group 250; whereas the frequency of the execution of the process of FIG. 4B may be generally determined by the number of phone conversations conducted by the user of communication device 110. Accordingly, it will also be appreciated that an individual media clip 136 may be played on the occasion of several different calls.

Conversely, it may be possible that some media clips 136 may not be played on the occasion of even a single call. For example, if the process of FIG. 4A is executed twice while the process of FIG. 4B waits (step 450) for call activity, then only the most recently posted media clip 136 may be played on the occasion of the next call related activity. The first clip may be “missed” and never be played within the context of call related activity.

In accordance with another preferred embodiment of the present invention, a user may view a list of such missed media clips 136 and may proactively play them. FIG. 5, to which reference is now made, illustrates an exemplary listing 500 of media clips 136 that may be displayed on communications device 110. For each media clip 136 listed, a video still 505, a buddy name 510, a relative time 515, and a caption 520 may be displayed. Video still 505 may be the first frame or a key frame of the associated media clip 136, and buddy name 510 and caption 520 may be derived from the associated buddy ID 320 and caption 340 stored in buddy media clip table 318. Listing 500 may include GUI controls to enable the user to select and play media clip 136. It will be appreciated that the number of media clips represented in FIG. 5 is exemplary and that other representations may also be implemented. Similarly, it will also be appreciated that listing 500 may comprise more than one display page.

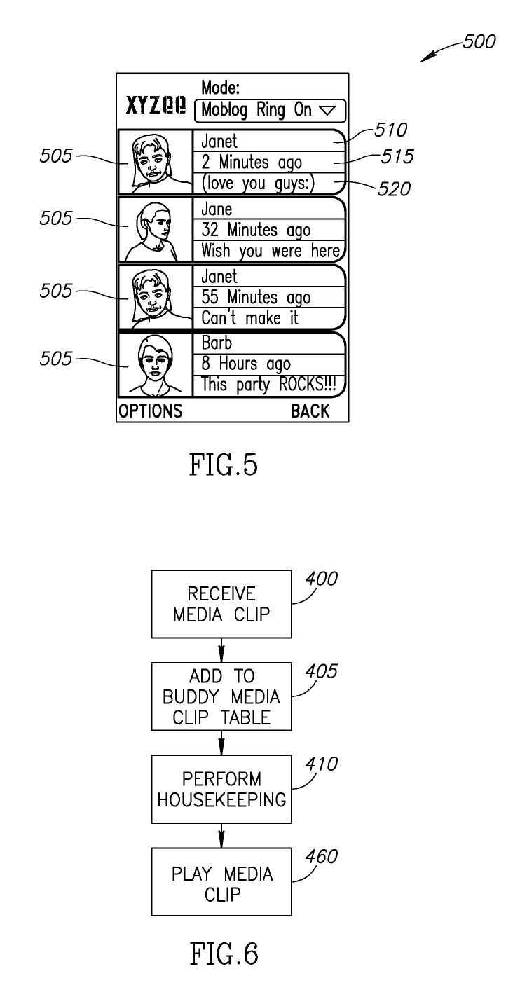

There may be some types of communications devices 110 that do not support the launching of media player 112 on the occasion of call-related activity. Some devices may not allow another process to take control while a call is in progress. In accordance with an alternative embodiment of the present invention, media clips 136 may be played shortly after they are downloaded. FIG. 6, to which reference is now made, illustrates how the process of FIG. 4A may be modified to provide this functionality.

As described hereinabove, communications device 110 may receive (step 400) media clip 136, add (step 405) an associated entry to buddy media clip table 318, and perform (step 410) required housekeeping. Once again, step 410 may be performed at any appropriate time.

In this embodiment, personalization content manager 137 may play (step 460) media clip 136 at some point after its arrival, without waiting for call-related activity on device 110. It will be appreciated that, while the process of FIG. 4B may not be used in parallel to the process of FIG. 6, a user may still use listing 500 to review previously played media clips 136.

It will be appreciated that, as described hereinabove, over time, older media clips 136 and their associated entries in buddy media clip table 318 may be deleted from communications device 110. However, media clips 134 (FIG. 2) associated with the deleted media clips 136 may remain on community server 136. In accordance with another preferred embodiment of the present invention, members of group 250 may access community server to review a listing of previously posted media clips 134. Users may select for download and/or play from this listing. It will be appreciated that members of group 250 may also use such a listing to view media clips 134 currently copied on their devices 110. Since community server 130 may be accessed from personal computer 170 (in addition to communications devices 110) it may be more convenient to view or download media clips 134 in such a manner.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
enabling members of a group to define a media clip for use as a common call-related media tone for said members.

2. The method according to claim 1 wherein said enabling comprises:
after receipt of a latest media clip from one member of said group, downloading said latest media clip to communications devices of said members.

3. The method according to claim 1 and also comprising providing a listing with details regarding said media clips to said communications devices.

4. The method according to claim 3 and wherein said details comprise at least one of the following: a name for said member that posted said media clip, a posting time stamp, an identifier for said media clip, an associated media clip, a link to an associated media clip, and a text message.

5. The method according to claim 4 and wherein said details are sorted according to said posted time stamps.

6. The method according to claim 3 and also comprising enabling said members to select and play said media clip from said listing.

7. A method comprising:
receiving group media clips on a communications device of a user belonging to a group that shares common media content; and
playing at least one of said group media clips on the occasion of call-related activity between said user and another of said members.

8. The method according to claim 7 and wherein said played media clip is the most recently defined said common media content available.

9. The method according to claim 7 and also comprising associating said received group media clip with each member of said group.

10. The method according to claim 7 and also comprising receiving details regarding said media clips.

11. The method according to claim 10 and wherein said details comprise at least one of the following: a name for said member that posted said media clip, a posting time stamp, a clip identifier for said media clip, an associated media clip, a link to an associated media clip and a text message.

12. The method according to claim 11 and wherein said details are sorted according to said posted time stamps.

13. The method according to claim 12 and also comprising enabling said user to select and play said media clip from said listing.

14. An apparatus comprising:
a database to store media clips; and
a group manager to enable members of a group to define a media clip from said database for use as a common call-related media tone for said members.

15. The apparatus according to claim 14 wherein also comprising:
a downloader to download a latest media clip defined by one member of said group to communications devices of said members.

16. The apparatus according to claim 14 and wherein said group manager comprises a group table with details regarding said media clips.

17. The apparatus according to claim 16 and also comprising a downloader to download said table to said communications devices.

18. The apparatus according to claim 16 and wherein said details comprise at least one of the following: a name for said member that posted said media clip, a posting time stamp, an identifier for said media clip, an associated media clip, a link to an associated media clip, and a text message.

19. The apparatus according to claim 18 and wherein said details are sorted according to said posted time stamps.

20. A communications device comprising:
a personalization content manager to receive group media clips of a group that shares common media content; and
a media player to play at least one of said group media clips on the occasion of call-related activity with another of said members.

21. The apparatus according to claim 20 and wherein said played media clip is the most recently defined said common media content available.

22. The apparatus according to claim 20 and wherein said personalization content manager comprises an associator to associate said received group media clip with each member of said group.

23. The apparatus according to claim 20 and wherein said personalization content manager comprises a listing of details regarding said media clips.

24. The apparatus according to claim 23 and wherein said details comprise at least one of the following: a name for said member that posted said media clip, a posting time stamp, a clip identifier for said media clip, an associated media clip, a link to an associated media clip and a text message.

25. The apparatus according to claim 24 and wherein said details are sorted according to said posted time stamps.

26. The apparatus according to claim 23 and wherein said personalization content manager comprises means to enable said user to select and play said media clip from said listing.
